(19) United States
(12) Patent Application Publication
(10) Pub. No.: US 2026/0219511 A1
(43) Pub. Date: Jul. 30, 2026

(54) OIS STRUCTURE WITH HEIGHT ADVANTAGES AND MOTOR

(71) Applicant: Xiamen Zhonghui Microelectronics Co., Ltd., Xiamen (CN)

(72) Inventors: WEI-HSIANG CHENG, Xiamen (CN); Yuqin Yi, Xiamen (CN); CHI-LUNG CHANG, Xiamen (CN)

(21) Appl. No.: 19/457,727

(22) Filed: Jan. 23, 2026

(30) Foreign Application Priority Data
Jan. 24, 2025 (CN) 202510118071X

(51) Int. Cl. G02B 27/64

(52) U.S. Cl. CPC G02B 27/646

(57) ABSTRACT

This disclosure relates to an OIS structure with height advantages and a motor, including a first guide member for guiding a bracket to move in a direction perpendicular to an optical axis. The first guide member includes a first side located above an optical axis direction and a second side located below the optical axis direction. The first side is matched with at least one first guide portion for guiding the bracket in a first direction, and the second side is matched with at least one second guide portion for guiding the bracket in a second direction. According to this disclosure, the brackets can move more stably and accurately in a plane perpendicular to the optical axis through the cooperative action of the guide portions in different directions on the first side and the second side.

### TECHNICAL FIELD

This disclosure relates to the field of optical imaging, and in particular, to an OIS structure with height advantages and a motor.

### BACKGROUND OF THE ART

In mobile terminals such as mobile phones, cameras are very commonly used components and parts, which offer the mobile terminal a shooting function. Generally, a height direction of the camera is consistent with a thickness direction of the mobile terminal, which indicates that the height of the camera may directly affect the thickness of the mobile terminal. Therefore, R&D personnel have been committed to researching how to reduce the height of the camera, so as to reduce the thickness of the mobile terminal, especially for cameras with an anti-shake function, which are the key focus.

There are some problems in the existing related art. For example, in the patent with the publication No. US20200310079A1, its OIS assembly adopts a double-layer ball structure, which can guide the OIS assembly to move in a direction perpendicular to an optical axis, but it has the defects of high cost and complex structure. More crucially, the OIS guide structure with double-layer balls may increase a motor height, which is contrary to the goal of reducing the height of a camera.

However, in the patent with the publication No. CN103869445A, the OIS assembly is supported by a plurality of single-layer balls to guide the OIS assembly to move in a direction perpendicular to the optical axis. Although this method reduces the height to a certain extent, a crosstalk problem is introduced, that is, rotation in the optical axis direction is introduced, thus causing unstable control and affecting the normal play and use experience of the anti-shake function.

### SUMMARY

To solve the above problems in the prior art, this disclosure provides an OIS motor structure with height advantages.

To achieve the above objectives, main technical solutions adopted by this disclosure are as follows:

An OIS structure with height advantages includes a first guide member for guiding a bracket to move in a direction perpendicular to an optical axis. The first guide member includes a first side located above an optical axis direction and a second side located below the optical axis direction. The first side is matched with at least one first guide portion for guiding the bracket in a first direction, and the second side is matched with at least one second guide portion for guiding the bracket in a second direction. The first direction is perpendicular to the second direction and both are perpendicular to the optical axis direction. A first sliding groove matched with the first guide portion is disposed at the bottom of the bracket. In a contact portion between the first guide portion and the first sliding groove, there is a trend of moving in a same direction and a limited distance in the first direction, to limit the bracket from linear displacement relative to the first guide portion in the first direction. A base is disposed at the bottom of the first guide member, and the base is provided with a second sliding groove matched with the second guide portion. In a contact portion between the second guide portion and the second sliding groove, there is a trend of moving in a same direction and a limited distance in the second direction, to limit the first guide member from linear displacement in the second direction.

Further, the first guide portion has a protruding height in front along the optical axis direction, the first guide portion includes at least two large balls (Specifically, the ball bearings mentioned in this application text are all simply referred to as balls) and a small ball disposed between adjacent large balls, the first guide member is provided with a first matching groove matched with the first guide portion, and the large balls and the first sliding groove form the contact portion; and the second guide portion has a protruding height behind the optical axis direction, the second guide portion includes at least two large balls and a small ball disposed between adjacent large balls, the first guide member is provided with a third matching groove matched with the second guide portion, and the large balls and the second sliding groove form the contact portion.

Further, one side of the first matching groove is provided with a second matching groove parallel to the first matching groove, a first auxiliary guide portion is disposed in the second matching groove, the first auxiliary guide portion is a ball, and the first matching groove is a V-shaped groove; and one side of the third matching groove is provided with a fourth matching groove parallel to the third matching groove, a second auxiliary guide portion is disposed in the fourth matching groove, the second auxiliary guide portion is a ball, and the third matching groove is a V-shaped groove.

Further, the first guide portion includes a limiting protrusion formed on the first guide member, and the limiting protrusion has a limited distance parallel to the first direction; and

the second guide portion includes a limiting protrusion formed on the first guide member, and the limiting protrusion has a limited distance parallel to the second direction.

Further, one side of the first guide portion is provided with a first auxiliary guide portion parallel to the first guide portion, the first auxiliary guide portion is a limiting protrusion integrally formed on the first guide member, and the first guide portion is a V-shaped limiting protrusion; and

one side of the second guide portion is provided with a second auxiliary guide portion parallel to the second guide portion, the second auxiliary guide portion is a limiting protrusion integrally formed on the first guide member, and the second guide portion is a V-shaped limiting protrusion.

A motor includes:

a housing in which a hollow cavity is formed;

a first bracket disposed in the hollow cavity and moving in an optical axis direction;

a second bracket disposed in the first bracket and moving in a direction perpendicular to the optical axis direction; and

the above-mentioned first guide member disposed between the second bracket and the first bracke.

Further, the housing includes an outer housing and a base, a bottom opening of the outer housing is fixedly connected to the base to form a hollow cavity internally, a light transmission hole is formed in the middle of the outer housing and the base, a top of the second bracket is provided with a cover plate, an edge of the cover plate is extended to form an extension plate matched with the first bracket, the extension plate is provided with a clamping groove, and the first bracket is provided with a clamping block matched with the clamping groove.

Further, an AF drive assembly for driving the first bracket to move is disposed between the first bracket and the housing, and the AF drive assembly includes an AF drive magnet disposed at the side of the first bracket and an AF drive coil disposed opposite to the AF drive magnet and located at an inner side of the housing; and

an OIS drive assembly for driving the second bracket to move is disposed between the second bracket and the housing, and the OIS drive assembly includes an OIS drive magnet disposed on the second bracket and an OIS drive coil disposed opposite to the OIS drive magnet and located on the housing.

Further, the housing is provided with a first limiting groove matched with an AF guide member, a second limiting groove matched with the AF guide member is disposed at an outer side of the first bracket, the AF guide member is a guide post, and the guide post is made of metal, plastic, or ceramic.

Further, the bracket is a second bracket, the base is a first bracket, the first bracket is provided with an relief groove, the relief groove is disposed opposite to the OIS drive magnet, one side of the first bracket close to the second bracket is provided with a mounting groove, a second guide member matched with the bottom of the second bracket is disposed in the mounting groove, and the second guide member is a ball.

This disclosure has the following beneficial effects: the brackets can move more stably and accurately in a plane perpendicular to the optical axis through the cooperative action of the guide portions in different directions on the first side and the second side, thus laying a foundation for realizing a more accurate anti-shake function. The guide portions ensure linear displacement of the brackets, avoid unexpected movement caused by similar crosstalk problems, and also effectively increase smoothness of sliding.

### BRIEF DESCRIPTION OF THE DRAWINGS

To describe the technical solutions in the embodiments of this disclosure more clearly, the following briefly describes the accompanying drawings required for describing the embodiments. It should be understood that the following accompanying drawings show merely some embodiments of this disclosure, and therefore should not be regarded as a limitation on the scope. Those of ordinary skill in the art may still derive other related accompanying drawings from these accompanying drawings without creative efforts.

FIG. 1 is an exploded view of a structure according to this disclosure;

FIG. 2 is a schematic structural diagram of a first guide member according to this disclosure;

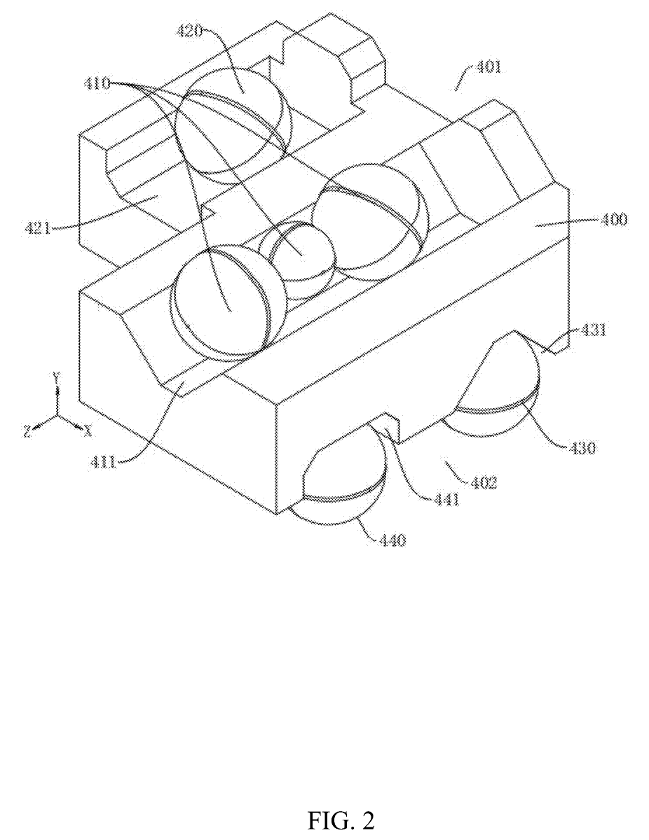

FIG. 3 is an exploded view according to another embodiment of this disclosure;

FIG. 4 is a schematic structural diagram of a first guide member according to another embodiment of this disclosure; and

FIG. 5 is a three-dimensional diagram of a first guide member according to another embodiment of this disclosure.

### REFERENCE NUMERALS IN THE ACCOMPANYING DRAWINGS

100. housing; 101. light transmission hole; 111. first limiting groove; 110. base; 120. outer housing; 130. cover plate; 131. extension plate; 132. clamping groove; 200. first bracket; 210. AF drive assembly; 211. AF drive magnet; 212. AF drive coil; 220. AF guide member; 221. second limiting groove; 230. second sliding groove; 240. mounting groove; 250. relief groove; 260. clamping block; 300. second bracket; 310. OIS drive assembly; 311. OIS drive magnet; 312. OIS drive coil; 320. first sliding groove; 400. first guide member; 401. first side; 402, second side; 410. first guide portion; 411. first matching groove; 420. first auxiliary guide portion; 421. second matching groove; 430. second guide portion; 431. third matching groove; 440. second auxiliary guide portion; 441. fourth matching groove; and 450. second guide member.

### DETAILED DESCRIPTION OF THE EMBODIMENTS

To make the objectives, technical solutions, and advantages of the embodiments of this disclosure clearer, the following clearly and completely describes the technical solutions in the embodiments of this disclosure with reference to the accompanying drawings in the embodiments of this disclosure. Apparently, the described embodiments are some but not all of the embodiments of this disclosure. Based on the embodiments in this disclosure, all other embodiments obtained by those of ordinary skill in the art without making creative efforts shall fall within the protection scope of this disclosure. Therefore, the detailed description of the embodiments of this disclosure provided in the accompanying drawings is not intended to limit the scope of the claimed disclosure, but only to represent selected embodiments of this disclosure.

In the description of this disclosure, it should be noted that the orientations or positional relationships indicated by the terms “up”, “down”, “inner”, “outer”, “front end”, “rear end”, “both ends”, “one end”, “the other end”, etc. are based on those shown in the accompanying drawings, intended only for the convenience of describing this disclosure and for simplifying the description, and not intended to indicate or imply that the referred apparatus or element must be provided with a particular orientation or constructed and operated with a particular orientation, therefore not allowed to be construed as a limitation of this disclosure. Furthermore, the terms “first” and “second” are used for descriptive purposes only and should not be construed as indication or implication of relative importance.

In the description of this disclosure, it should be noted that, unless otherwise explicitly provided and limited, the terms “mounted”, “disposed”, and “connected” should be understood in a broad sense, e.g., “connected” may be a fixed connection, a detachable connection, or an integral connection; it may be a mechanical connection or an electrical connection; it may be a direct connection or an indirect connection through an intermediate medium; and it may be a connection between two elements. For a person of ordinary skill in the art, the specific meanings of the above terms in this disclosure may be understood based on specific circumstances.

### Embodiments

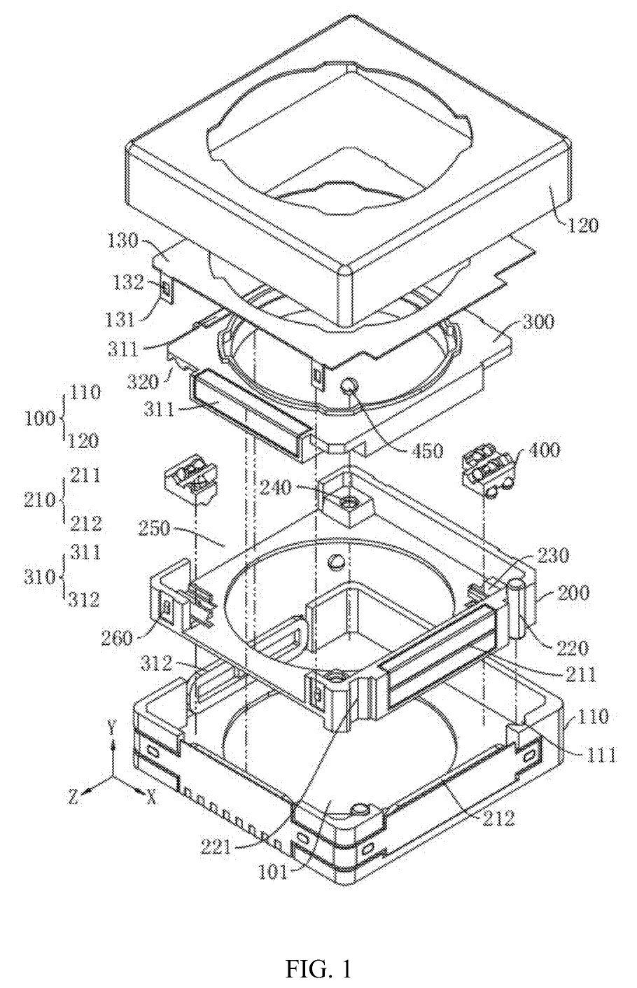

As shown in FIG. 1, an optical axis direction is parallel to a Y direction, a first direction is parallel to a Z direction, and a second direction is parallel to an X direction. For the convenience of description, the optical axis direction can also be called the Y direction, the first direction can also be called the Z direction, and the second direction can also be called the X direction.

An OIS structure with height advantages includes a first guide member 400 for guiding a bracket to move in a direction perpendicular to the optical axis direction. The first guide member 400 includes a first side 401 located above the optical axis direction and a second side 402 located below the optical axis direction. The first side 401 is matched with at least one first guide portion 410 for guiding the bracket in the first direction, and the second side 402 is matched with at least one second guide portion 430 for guiding the bracket in the second direction. The first direction is perpendicular to the second direction and both are perpendicular to the optical axis direction. The design of the first guide member 400 and the guide portions at both sides improves the guiding accuracy. The brackets can move more stably and accurately in a plane perpendicular to the optical axis through the cooperative action of the guide portions in different directions on the first side 401 and the second side 402, thus laying a foundation for realizing a more accurate anti-shake function. The structural complexity is optimized. Compared with a double-layer ball structure, this design simplifies the structure while ensuring the guiding function, which is conducive to reducing the cost and production difficulty. An integrated structure can effectively reduce a height (a dimension in the Y direction).

A first sliding groove 320 matched with the first guide portion 410 is disposed at the bottom of the bracket, and in a contact portion between the first guide portion 410 and the first sliding groove 320, there is a trend of moving in a same direction and a limited distance in the first direction, to limit the bracket from linear displacement relative to the first guide portion 410 in the first direction. Deviating or unstable movement of the bracket in the first direction are prevented, thus avoiding unexpected movement caused by similar crosstalk problems. Linear displacement of the bracket in the first direction is ensured. In the contact portion between the first guide portion 410 and the first sliding groove 320, there are the trend of moving in the same direction and the limited distance in the first direction, which limits the bracket to only realize linear displacement in the first direction when it cooperates with the first guide portion 410, thus improving the stability and controllability of the movement. The reliability of the anti-shake function is enhanced. Accurate linear displacement can make camera lens maintain stable position adjustment in the anti-shake process, thus improving the stability and clarity of shooting pictures.

A base is disposed at the bottom of the first guide member 400, the base is provided with a second sliding groove 230 matched with the second guide portion 430, and in a contact portion between the second guide portion 430 and the second sliding groove 230, there is a trend of moving in a same direction and a limited distance in the second direction, to limit the first guide member 400 from linear displacement in the second direction. Similarly, it is to ensure stable movement of the first guide member 400 in the second direction, avoid unnecessary shaking or deviation, and solve various problems caused by unstable guidance in the prior art. The movement of the first guide member 400 will further drive the bracket to have a stable moving track in the second direction, thus realizing accurate movement of the bracket in the direction perpendicular to the optical axis direction, and further ensuring the stability of the whole structure. Through the cooperation between the second sliding groove 230 and the second guide portion 430 on the base, the first guide member 400 can also realize accurate linear displacement in the second direction, thus ensuring that the whole OIS structure can realize stable operation in the plane perpendicular to the optical axis.

In an embodiment, the first guide portion 410 has a protruding height in front along the optical axis direction, and this design can increase the contact area and force between the guide portion and the bracket to a certain extent, thus improving the guiding accuracy and stability of the bracket. During the movement of the bracket, a larger contact area can better disperse the force, reduce local wear, and prolong the service life of components.

The first guide portion 410 includes at least two large balls and a small ball disposed between adjacent large balls, the first guide member 400 is provided with a first matching groove 411 matched with the first guide portion 410, and the large balls and the first sliding groove 320 form the contact portion. The first matching groove 411 can accurately position the first guide portion 410, and ensure its position accuracy in the operation process. In addition, the design of the matching grooves is also helpful to closely combine the first guide portion 410 and the first guide member 400, so as to form a stable whole and jointly provide accurate guide services for the bracket.

There are many advantages in the combination of large and small balls. The large balls can provide main support and guiding function, and ensure that the bracket can move stably under a larger load, while the small balls are filled in gaps between the large balls. On the one hand, a spacing between the large balls can be further increased, which is helpful to increase the limited distance of the second guide portion 430 in the second direction and improve the guide straightness and stability; on the other hand, when the large balls move, the small balls can play a role of assisting rolling and buffering, reduce direct friction between the large balls, and improve the smoothness and stability of a whole guide system. Furthermore, the small balls are the key to realize a same direction movement of the large balls, thus ensuring smooth rolling. In a traditional structure, a single-point supporting structure with a single ball is usually adopted, which may cause excessive local pressure and the deformation of the bracket, and meanwhile, the guiding linearity is not good, which is easy to produce rotation in the optical axis direction (rotation in the Y axis). However, in some multi-ball structures, the size of the balls is the same; when the bracket moves in one direction, two adjacent balls will interact with each other when approaching, resulting in opposite rolling directions, which may lead to not smooth rolling, and some balls cannot cooperate with the bracket in a rolling friction manner, which may lead to not smooth rolling and even shaking, thus affecting the anti-shake effect. In this structure, it is illustrated with a structure of two large balls and one small ball. The small ball is clamped between the two large balls, and the small ball is not in direct contact with the bracket. The two large balls can rotate in a same direction. Even if the three balls are close to each other when rolling, the conduction of the small ball between them also promotes the two large balls to rotate in the same direction, effectively ensures the smoothness of movement, and reduces the occurrence of shake. The contact position between the two large balls and the first sliding groove 320 forms the contact portion, in this case, a minimum distance of the limited distance is the sum of diameters of the large balls and the small ball, and this limited distance can effectively prevent the bracket from rotating in the optical axis direction (rotation along the Y axis).

The second guide portion 430 has a protruding height behind the optical axis direction, the second guide portion 430 includes at least two large balls and a small ball disposed between adjacent large balls, the first guide member 400 is provided with a third matching groove 431 matched with the second guide portion 430, and the large balls and the second sliding groove 230 form a contact portion. The second guide portion 430 has the protruding height behind the optical axis direction, and cooperates with the protruding height in the front of the first guide portion 410, so as to restrain and guide the bracket from front and rear directions. This front-back symmetrical protruding height design can better balance the force of the bracket in the plane perpendicular to the optical axis, and further improve the movement stability and straightness of the bracket. Like the first guide portion 410, the second guide portion 430 adopts a combination manner of at least two large balls and a small ball between adjacent large balls, which also has the advantages of improving guide uniformity, increasing contact points, buffering, and the like, and ensures that the first guide member 400 has stable and smooth movement in the second direction. The first guide member 400 is provided with the third matching groove 431 matched with the second guide portion 430, and its function is similar to that of the first matching groove 411, which can accurately position the second guide portion 430 and enhance the stability of connection between the second guide portion 430 and the first guide member 400, thus ensuring the guiding accuracy and reliability of the whole OIS structure in the second direction.

In an embodiment, one side of the first matching groove 411 is provided with a second matching groove 421 parallel to the first matching groove 411, a first auxiliary guide portion 420 is disposed in the second matching groove 421, the first auxiliary guide portion 420 is a ball, and the first matching groove 411 is a V-shaped groove. This design further enhances the ability of guiding and supporting the first guide portion 410. During the movement of the bracket, when the first guide portion 410 rolls in the first matching groove 411, the ball in the second matching groove 421 can provide additional auxiliary guiding function from the side, so as to prevent the first guide portion 410 from shifting or shaking during the movement, thus further improving the movement stability and accuracy of the bracket in the first direction. The first matching groove 411 adopts a V-shaped groove structure, which has unique advantages. The V-shaped groove can better cooperate with the balls, so that the balls can roll more stably and smoothly in the groove. Two side walls of the V-shaped groove can restrain the balls, prevent the balls from getting off the track during the movement, and ensure the guiding reliability. Meanwhile, the V-shaped groove structure can make the contact between the balls and the groove wall closer, which is beneficial to transmission of the force, thus improving the guiding accuracy and efficiency.

One side of the third matching groove 431 is provided with a fourth matching groove 441 parallel to the third matching groove 431, a second auxiliary guide portion 440 is disposed in the fourth matching groove 441, the second auxiliary guide portion 440 is a ball, and the third matching groove 431 is a V-shaped groove. One side of the third matching groove 431 is provided with the parallel fourth matching groove 441, and the ball as the second auxiliary guide portion 440 is disposed in the fourth matching groove 441, which is similar to design principles of the first matching groove 411 and the second matching groove 421. When the first guide member 400 moves in the second direction, the ball in the fourth matching groove 441 can provide side auxiliary guiding function for the second guide portion 430, which enhances the stability of the second guide portion 430 in the movement, and ensures that the first guide member 400 moves in the second direction more accurately and reliably. The third matching groove 431 also adopts a V-shaped groove structure, which has the same advantages as the V-shaped groove of the first matching groove 411. This structure can make the ball of the second guide portion 430 roll stably in the groove, effectively restrain the movement track of the ball, prevent the ball from falling off, ensure the guiding stability and reliability in the second direction, and guarantee the accurate movement of the whole OIS structure in the second direction.

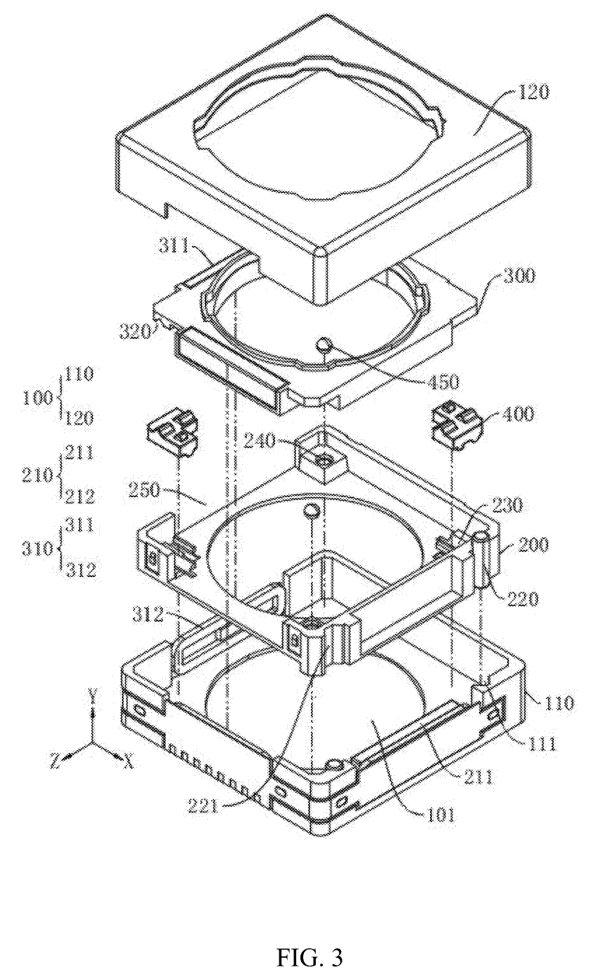

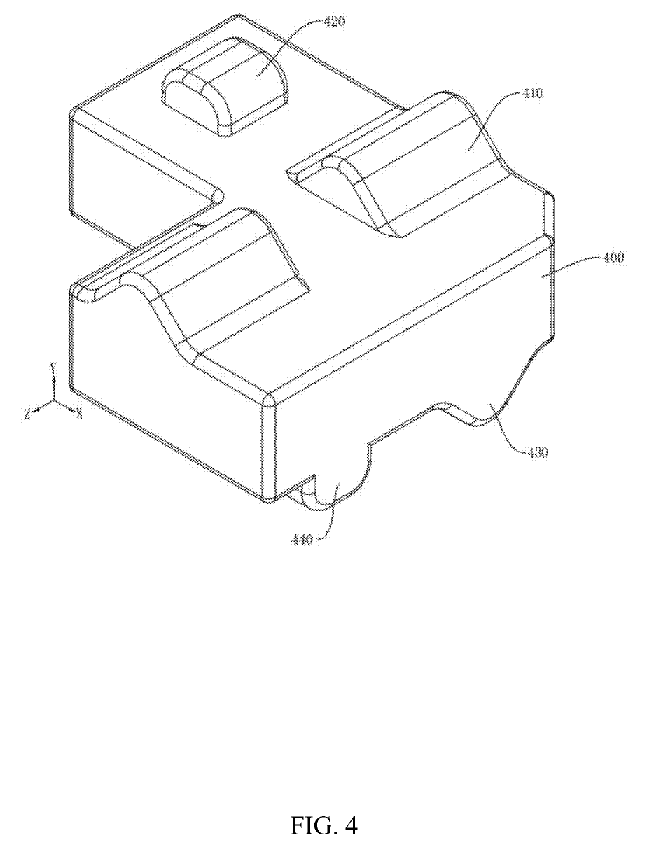

As shown in FIG. 3 and FIG. 4, in an embodiment, the first guide portion 410 includes a limiting protrusion formed on the first guide member 400, and the limiting protrusion has a limited distance parallel to the first direction. This design can accurately limit the movement of the bracket in the first direction. When the bracket moves in the first direction, the limiting protrusion can prevent the bracket from exceeding a limited range, thus avoiding structural damage or unstable movement caused by excessive displacement. This design ensures that the bracket always moves in a set track in the first direction, which greatly improves the movement stability and reliability of the bracket. Compared with some complicated limiting mechanisms, this limiting way by limiting protrusions has a simpler structure. Simple structural design is not only convenient for production and manufacturing, but also can reduce the production cost. Meanwhile, possible failure points due to too many components and parts are reduced, and the durability of the whole OIS structure is improved. The limiting protrusion and the first guide member 400 are generally in an integrated structure, and the setting of the limiting protrusion can minimize a dimension in the height direction (the Y direction). A height dimension of a first limiting member can use the height dimension of a single-side ball to realize the guiding effect of a double-layer ball and better displacement linearity, which avoids the rotation in the optical axis direction (rotation along the Y axis). The first guide member 400 can be a wear-resistant self-lubricating sliding block made of engineering plastics (such as POM, POM+PTFE, and PEEK), which is beneficial to reducing an overall height. This structural design not only achieves good guiding function, but also does not increase height too much, which is in line with the R&D goal of reducing the height of the camera and is helpful to realize the thinness of mobile terminals.

The second guide portion 430 includes a limiting protrusion formed on the first guide member 400, and the limiting protrusion has a limited distance parallel to the second direction. The limiting protrusion of the second guide portion 430 and the limiting protrusion of the first guide portion 410 cooperate with each other to restrict the movements of the bracket and the first guide member 400 from two vertical directions. This all-around limit design enhances the stability of the whole OIS structure, so that it can maintain a stable working state under various working conditions and reduce performance degradation or failure caused by out-of-control movement.

As shown in FIG. 4, in an embodiment, one side of the first guide portion 410 is provided with a first auxiliary guide portion 420 parallel to the first guide portion 410, the first auxiliary guide portion 420 is a limiting protrusion integrally formed on the first guide member 400, and the first guide portion 410 is a V-shaped limiting protrusion. This double guide structure greatly enhances the control ability of the bracket in the first direction. When the bracket moves, the first guide portion 410 and the first auxiliary guide portion 420 can limit and guide the bracket from different positions at the same time, so as to avoid the bracket from shifting or shaking, and to make the movement of the bracket in the first direction more stable and reliable. The first guide portion 410 adopts a V-shaped limiting protrusion structure, and the V-shaped design can better cooperate with the bracket. Two V-shaped side walls can restrain the bracket more accurately, so that the bracket can always stay on a correct track during the movement, and further improve the guiding accuracy. Meanwhile, the V-shaped structure can better disperse the force, reduce wear caused by excessive local force, and prolong the service life of components.

One side of the second guide portion 430 is provided with a second auxiliary guide portion 440 parallel to the second guide portion 430, the second auxiliary guide portion 440 is a limiting protrusion integrally formed on the first guide member 400, and the second guide portion 430 is a V-shaped limiting protrusion. This design plays a good auxiliary guiding role in the movement of the first guide member 400 and the bracket in the second direction. When the first guide member 400 drives the bracket to move in the second direction, the second guide portion 430 and the second auxiliary guide portion 440 cooperate to ensure the accuracy and stability of the movement, and effectively avoid the adverse effects on the anti-shake function caused by the movement deviation.

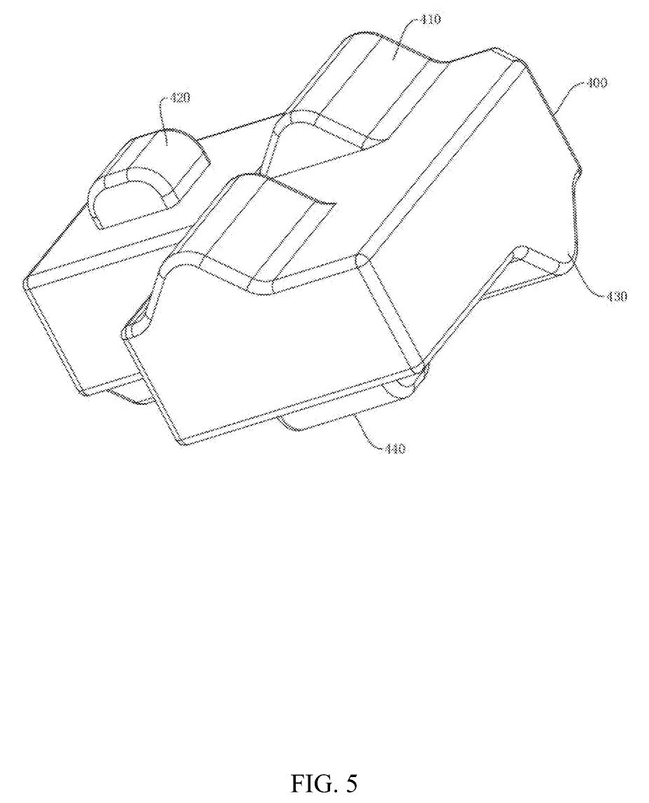

As shown in FIG. 5, in an embodiment, a dimension of the second auxiliary guide portion 440 in the second direction can be appropriately reduced, so as to reduce a contact area of the protrusion to reduce friction force.

As shown in FIG. 1, a motor includes a housing 100 in which a hollow cavity is formed; a first bracket 200 disposed in the hollow cavity and moving in an optical axis direction; a second bracket 300 disposed in the first bracket 200 and moving in a direction perpendicular to the optical axis direction; and the above-described first guide member 400 disposed between the second bracket 300 and the first bracket 200. This design realizes accurate control of the movement of the second bracket 300 in different directions. The movement of the first bracket 200 in the optical axis direction can adjust parameters such as a focal length of the lens, while the movement of the second bracket 300 in a direction perpendicular to the optical axis under the action of the first guide member 400 provides a foundation for the anti-shake function. Cooperative work of the two enables the motor to meet various shooting requirements and improve the shooting effect. The double guide structure of the first guide member 400 and the arrangement of the auxiliary guide portions ensure the stability of the second bracket 300 during the movement. Even in a complicated use environment or severe hand shaking condition, the second bracket 300 can also keep on a correct motion track, which reduces the blur or jitter of pictures caused by shaking and improves the reliability of the motor in actual use.

In an embodiment, the housing 100 includes an outer housing 120 and a base 110, a bottom opening of the outer housing 120 is fixedly connected to the base 110 to form a hollow cavity internally, a light transmission hole 101 is formed in the middle of the outer housing 120 and the base 110. The fixed connection between the outer housing 120 and the base 110 forms a stable hollow structure, which provides reliable support and protection for the internal components such as the first bracket 200 and the second bracket 300. During the use of the motor, it can effectively resist external collision and extrusion, ensure the normal operation of internal precision components, and prolong the service life of the motor.

In an embodiment, a top of the second bracket is provided with a cover plate 130, an edge of the cover plate 130 is extended to form an extension plate 131 matched with the first bracket 200, the extension plate 131 is provided with a clamping groove 132, and the first bracket 200 is provided with a clamping block 260 matched with the clamping groove 132. The clamping between the cover plate 130 and the first bracket 200 can effectively limit the position of the second bracket 300, which is helpful for effective contact of the first guide member 400 with the first bracket 200 and the second bracket 300 and ensures that the mobility of the second bracket 300 will not fail. The cover plate 130 can also limit a moving distance of the second bracket 300, a middle portion of the cover plate 130 is also provided with a light transmission hole, and an upper surface of the second bracket 300 is extended to form a convex edge/flange matched with the light transmission hole, so as to limit the second bracket 300.

In an embodiment, an AF drive assembly 210 for driving the first bracket 200 to move is disposed between the first bracket 200 and the housing 100, and the AF drive assembly 210 includes an AF drive magnet 211 disposed at the side of the first bracket 200 and an AF drive coil 212 disposed opposite to the AF drive magnet 211 and located at an inner side of the housing 100. The first bracket 200 can be accurately driven to move in the optical axis direction through electromagnetic interaction. This accurate driving control enables the lens to quickly and accurately adjust the focal length and realize an auto-focusing function.

An OIS drive assembly 310 for driving the second bracket 300 to move is disposed between the second bracket 300 and the housing 100, and the OIS drive assembly 310 includes an OIS drive magnet 311 disposed on the second bracket 300 and an OIS drive coil 312 disposed opposite to the OIS drive magnet 311 and located on the housing 100. The second bracket 300 can be driven to move in a direction perpendicular to the optical axis through the action of electromagnetic force, thus effectively counteracting the shaking caused by hand shake or other external factors.

In an embodiment, the housing 100 is provided with a first limiting groove 111 matched with an AF guide member 220, a second limiting groove 221 matched with the AF guide member 220 is disposed at an outer side of the first bracket 200, the AF guide member 220 is a guide post, and the guide post is made of metal, plastic, or ceramic. When the AF drive assembly works, the first bracket 200 needs to move linearly in the optical axis direction to realize the focusing function. The cooperation of the guide post between the two limiting grooves ensures that the first bracket 200 can only move in the set optical axis direction, avoiding focusing deviation caused by displacement or shaking in other directions, thus ensuring the accuracy and stability of the auto-focusing function.

In an embodiment, the bracket is a second bracket 300, the base is a first bracket 200, the first bracket 200 is provided with an relief groove 250, the relief groove 250 is disposed opposite to the OIS drive magnet, one side of the first bracket 200 close to the second bracket 300 is provided with a mounting groove 240, a second guide member 450 matched with the bottom of the second bracket 300 is disposed in the mounting groove 240, and the second guide member 450 is a ball. This design enhances the guiding stability of the movement of the second bracket 300. When the second bracket 300 moves, the balls roll in the mounting groove 240, which can provide stable support and guidance for the second bracket 300 from the bottom, so that the movement of the second bracket 300 is more stable and the shaking and deviation are reduced. The ball, as the guide member 220, has a low friction coefficient. During the movement of the second bracket 300, a rolling friction between the ball and the bottom of the second bracket 300 and the mounting groove 240 is much smaller than a sliding friction, which greatly reduces a friction resistance during the movement.

The above-described embodiments are only embodiments of this disclosure and do not limit the patent protection scope of this disclosure. Any equivalent transformations based on the content of the specification and accompanying drawings of this disclosure, or direct or indirect application of the above-described embodiments in related technical fields are all included in the patent protection scope of this disclosure for the same reason.

1. An OIS structure with height advantages, comprising a first guide member (400) for guiding a bracket to move in a direction perpendicular to an optical axis, wherein the first guide member (400) comprises a first side (401) located above an optical axis direction and a second side (402) located below the optical axis direction, the first side (401) is matched with at least one first guide portion (410) for guiding the bracket in a first direction, the second side (402) is matched with at least one second guide portion (430) for guiding the bracket in a second direction, the first direction is perpendicular to the second direction and both are perpendicular to the optical axis direction, a first sliding groove (320) matched with the first guide portion (410) is disposed at the bottom of the bracket, in a contact portion between the first guide portion (410) and the first sliding groove (320), there is a trend of moving in a same direction and a limited distance in the first direction, to limit the bracket from linear displacement relative to the first guide portion (410) in the first direction, a base is disposed at the bottom of the first guide member (400), the base is provided with a second sliding groove (230) matched with the second guide portion (430), and in a contact portion between the second guide portion (430) and the second sliding groove (230), there is a trend of moving in a same direction and a limited distance in the second direction, to limit the first guide member (400) from linear displacement in the second direction.

2. The OIS structure with height advantages according to claim 1, wherein the first guide portion (410) has a protruding height in front along the optical axis direction, the first guide portion (410) comprises at least two large balls and a small ball disposed between adjacent large balls, the first guide member (400) is provided with a first matching groove (411) matched with the first guide portion (410), and the large balls and the first sliding groove (320) form a contact portion; and
the second guide portion (430) has a protruding height behind the optical axis direction, the second guide portion (430) comprises at least two large balls and a small ball disposed between adjacent large balls, the first guide member (400) is provided with a third matching groove (431) matched with the second guide portion (430), and the large balls and the second sliding groove (230) form a contact portion.

3. The OIS structure with height advantages according to claim 2, wherein one side of the first matching groove (411) is provided with a second matching groove (421) parallel to the first matching groove (411), a first auxiliary guide portion (420) is disposed in the second matching groove (421), the first auxiliary guide portion (420) is a ball, and the first matching groove (411) is a V-shaped groove; and
one side of the third matching groove (431) is provided with a fourth matching groove (441) parallel to the third matching groove (431), a second auxiliary guide portion (440) is disposed in the fourth matching groove (441), the second auxiliary guide portion (440) is a ball, and the third matching groove (431) is a V-shaped groove.

4. The OIS structure with height advantages according to claim 1, wherein the first guide portion (410) comprises a limiting protrusion formed on the first guide member (400), and the limiting protrusion has a limited distance parallel to the first direction; and
the second guide portion (430) comprises a limiting protrusion formed on the first guide member (400), and the limiting protrusion has a limited distance parallel to the second direction.

5. The OIS structure with height advantages according to claim 4, wherein one side of the first guide portion (410) is provided with a first auxiliary guide portion (420) parallel to the first guide portion (410), the first auxiliary guide portion (420) is a limiting protrusion integrally formed on the first guide member (400), and the first guide portion (410) is a V-shaped limiting protrusion; and
one side of the second guide portion (430) is provided with a second auxiliary guide portion (440) parallel to the second guide portion (430), the second auxiliary guide portion (440) is a limiting protrusion integrally formed on the first guide member (400), and the second guide portion (430) is a V-shaped limiting protrusion.

6. A motor, comprising:
a housing (100) in which a hollow cavity is formed;
a first bracket (200) disposed in the hollow cavity and moving in an optical axis direction;
a second bracket (300) disposed in the first bracket (200) and moving in a direction perpendicular to the optical axis direction; and
the first guide member (400) according to claim 1 disposed between the second bracket (300) and the first bracket (200).

7. The motor according to claim 6, wherein the housing (100) comprises an outer housing (120) and a base (110), a bottom opening of the outer housing (120) is fixedly connected to the base (110) to form a hollow cavity internally, a light transmission hole (101) is formed in the middle of the outer housing (120) and the base (110), a top of the second bracket is provided with a cover plate (130), an edge of the cover plate (130) is extended to form an extension plate (131) matched with the first bracket (200), the extension plate (131) is provided with a clamping groove (132), and the first bracket (200) is provided with a clamping block (260) matched with the clamping groove (132).

8. The motor according to claim 6, wherein an AF drive assembly (210) for driving the first bracket (200) to move is disposed between the first bracket (200) and the housing (100), and the AF drive assembly (210) comprises an AF drive magnet (211) disposed at the side of the first bracket (200) and an AF drive coil (212) disposed opposite to the AF drive magnet (211) and located at an inner side of the housing (100); and
an OIS drive assembly (310) for driving the second bracket (300) to move is disposed between the second bracket (300) and the housing (100), and the OIS drive assembly (310) comprises an OIS drive magnet (311) disposed on the second bracket (300) and an OIS drive coil (312) disposed opposite to the OIS drive magnet (311) and located on the housing (100).

9. The motor according to claim 6, wherein the housing (100) is provided with a first limiting groove (111) matched with an AF guide member (220), a second limiting groove (221) matched with the AF guide member (220) is disposed at an outer side of the first bracket (200), the AF guide member (220) is a guide post, and the guide post is made of metal, plastic, or ceramic.

10. The motor according to claim 8, wherein the bracket is a second bracket (300), the base is a first bracket (200), the first bracket (200) is provided with an relief groove (250), the relief groove (250) is disposed opposite to the OIS drive magnet, one side of the first bracket (200) close to the second bracket (300) is provided with a mounting groove (240), a second guide member (450) matched with the bottom of the second bracket (300) is disposed in the mounting groove (240), and the second guide member (450) is a ball.

11. A motor, comprising:
a housing (100) in which a hollow cavity is formed;
a first bracket (200) disposed in the hollow cavity and moving in an optical axis direction;
a second bracket (300) disposed in the first bracket (200) and moving in a direction perpendicular to the optical axis direction; and
the first guide member (400) according to claim 2 disposed between the second bracket (300) and the first bracket (200).

12. The motor according to claim 11, wherein the housing (100) comprises an outer housing (120) and a base (110), a bottom opening of the outer housing (120) is fixedly connected to the base (110) to form a hollow cavity internally, a light transmission hole (101) is formed in the middle of the outer housing (120) and the base (110), a top of the second bracket is provided with a cover plate (130), an edge of the cover plate (130) is extended to form an extension plate (131) matched with the first bracket (200), the extension plate (131) is provided with a clamping groove (132), and the first bracket (200) is provided with a clamping block (260) matched with the clamping groove (132).

13. The motor according to claim 11, wherein an AF drive assembly (210) for driving the first bracket (200) to move is disposed between the first bracket (200) and the housing (100), and the AF drive assembly (210) comprises an AF drive magnet (211) disposed at the side of the first bracket (200) and an AF drive coil (212) disposed opposite to the AF drive magnet (211) and located at an inner side of the housing (100); and
an OIS drive assembly (310) for driving the second bracket (300) to move is disposed between the second bracket (300) and the housing (100), and the OIS drive assembly (310) comprises an OIS drive magnet (311) disposed on the second bracket (300) and an OIS drive coil (312) disposed opposite to the OIS drive magnet (311) and located on the housing (100).

14. The motor according to claim 11, wherein the housing (100) is provided with a first limiting groove (111) matched with an AF guide member (220), a second limiting groove (221) matched with the AF guide member (220) is disposed at an outer side of the first bracket (200), the AF guide member (220) is a guide post, and the guide post is made of metal, plastic, or ceramic.

15. The motor according to claim 13, wherein the bracket is a second bracket (300), the base is a first bracket (200), the first bracket (200) is provided with an relief groove (250), the relief groove (250) is disposed opposite to the OIS drive magnet, one side of the first bracket (200) close to the second bracket (300) is provided with a mounting groove (240), a second guide member (450) matched with the bottom of the second bracket (300) is disposed in the mounting groove (240), and the second guide member (450) is a ball.
